(19) United States
(12) Patent Application Publication
(10) Pub. No.: US 2009/0223002 A1
(43) Pub. Date: Sep. 10, 2009

(54) Pad-dyed, bleach-resistant fabrics

(76) Inventor: Kenneth Kuk-Kei Wang, Sai Kung (HK)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/074,630

(22) Filed: Mar. 5, 2008

(51) Int. Cl. C09B 67/04

(52) U.S. Cl. 8/552

(57) ABSTRACT

A pad-dyed or foam-dyed, pigment-colored, cellulose-based fabric that does not discolor upon chlorine bleaching of the fabric is provided. The fabric is dyed by grinding pigment colorants of a desired color to an ultra fine size and blending the grinded pigment colorants with one or more binders and, optionally, one or more additives, to form a padding paste. The padding paste is then prepared for pad dyeing or foam dyeing, and the fabric is pad dyed or foam dyed using the prepared padding paste.

### FIELD OF THE INVENTION

The present invention relates to a bleach-resistant fabric and, more particularly, to a pad-dyed, pigment-colored, cellulose-based fabric that does not discolor or fade upon bleaching. Specifically, the present invention relates to the use of ultra-fine pigment colorants in the pad-dying of cotton towels and other cellulose-based fabrics and/or fibers made into fabrics such that the fabrics will withstand bleaching standards required by the hospitality trade and household environments. In an alternative embodiment, the fabrics of the present invention may be foam-dyed, rather than pad-dyed.

### BACKGROUND OF THE INVENTION

In the hospitality industry, such as hotels, spas and the like, it is required that towels and other fabrics used in the industry be perceived as sanitary. Therefore, the hospitality industry requires that these fabrics conform to certain sanitation criteria. As there has been a rise in the possibility of contracting various contagious diseases (e.g., bird flu) over the past few years, many in the hospitality industry now require bleaching of the towels and other fabrics used in the hotels and various places where repeated use of the towels and fabrics will or is likely to occur. This, of course, eliminates many of the types and colors of towels and fabrics that can be used in the hospitality industry and is one reason why many of the towels and linens used by hotels, spas, and other hospitality places are dyed white or not dyed at all.

Similarly, in the pet clothing industry, there is also a demand for fabrics that can be easily cleaned by bleaching to remover, dirt, bacteria, and even viruses. Like the hospitality industry, this industry also requires its fabrics to be clean and hygienic, but also require soft hand feel and other luxurious and quality fabrics. Therefore, the fabrics should be bleach-resistant so that the colors of the pets' clothing can retain a new, sanitary and fresh look and feel. Examples of pet clothing may include pet sweaters, pet knits, pet raincoats, pet collars, pet caps and hats, pet carrying bags, pet portable bowls, and pet bed clothing.

Chlorine bleach is a well known antimicrobial agent and an excellent disinfecting agent. Chlorine bleach may also be referred to as hypochlorite in some industries. It is often used to provide sanitation to fabrics and the like that can be washed. The consuming public perceives that bleaching with chlorine will provide the necessary sanitation to fabrics that will prevent communicable or transmittable diseases that may be perceived as not preventable by regular detergents during washing. Similarly, bleaching with hydrogen peroxide is also possible.

At present, however, there are very few colors and even fewer processes for the dyeing of cellulosic fabrics, such as cotton towels, that will withstand chlorine bleaching. One known process that has been used heretofore requires a cotton towel to be first vat dyed and bleached so that further bleaching will not discolor the towel. Consequently, the towel has essentially already been discolored by bleaching before it is sold to the hospitality industry. Vat dyes are a class of water-soluble dyes that are applied to the fiber or fabrics in a reduced, soluble form and then re-oxidized to the original insoluble form. Vat dyes are commonly believed to be among the most resistant dyes to both washing and sunlight and are widely used to color cellulosic fabrics and fibers. Disadvantageously, however, this known process is very unreliable and difficult to repeat. Nevertheless, towels made from the vat-dyeing process are said to have a soft hand feel.

Thus, the need exists for bleach-resistant, cellulose-based fabrics, such as cotton towels and other woven fabrics that can be dyed and yet maintain their high color fastness during washing and, in particular, chlorine bleaching. In addition to color fastness, the fabrics desirably have highly absorbency and bulkiness to give an intimate, soft feeling to the user, comparable to that of vat-dyed fabrics.

### SUMMARY OF THE INVENTION

At least one or more of the foregoing aspects of the present invention, together with the advantages thereof over the known art relating to bleach-resistant fabrics and dyeing processes for fabrics, which shall become apparent from the specification and drawings that follows, are accomplished by the invention as hereinafter described and claimed.

The present invention provides a pad-dyed, pigment-colored, cellulose-based fabric that does not discolor upon chlorine bleaching of the fabric.

In accordance with another embodiment, the present invention provides a method for dyeing a cellulose fiber-based fabric comprising grinding pigment colorants of a desired color to a size no larger than about 1 micron in diameter; blending the ground pigment colorants with one or more binders and, optionally, one or more additives, to form a padding paste; preparing the padding paste for use in pad dyeing; and pad dyeing the fabric.

In accordance with yet another embodiment, the present invention provides a colored fabric of cellulose fibers, the fabric comprising pigment colorants of a desired color having a diameter sufficiently small to penetrate the fibers of the fabric upon pad dyeing of the fabric.

In another embodiment, the present invention provide a foam-dyed, pigment-colored, cellulose fabric that does not discolor upon chlorine bleaching of the fabric.

### DETAILED DESCRIPTION OF THE PREFERRED EMBODIMENTS

As stated above, the present invention is directed toward a pad-dyed, pigment-colored, cellulose-based fabric that does not discolor or fade upon bleaching of the fabric. The colored fabrics may be bleached with any known bleach or bleaching agent but are particularly able to withstand bleaching wherein the bleach includes a chlorine (Cl⁻) ion. Examples of such chlorine bleaches include, but are not limited to, for example, sodium hypochlorite, NaHClO, and potassium hypochlorite, KHClO. Other potential bleaching agents would include hydrogen peroxide, H2O2. It is well known that such chlorine bleaches discolor or fade many colored fabrics during washing of the fabrics, and particularly discolor and fade most, if not all, cellulose-based fabrics. Therefore, the ability to provide a colored, cellulose-based fabric that does not bleed, discolor or fade upon chlorine bleaching is seen as advantageous to the art, particularly in the hospitality industry.

In addition to withstanding chlorine bleaching, the fabrics of the present invention also at least maintain the soft hand feel and high liquid absorbency associated with many fabrics and towels in the hospitality industry. The fabrics of the present invention are particularly suitable for use as towels, but may be used for other applications as well, where colored fabrics may be desired. For instance, many colored fabrics for pet clothing cannot be bleached in the manner desired, even though such fabrics are highly sought.

By the term “colored,” it is meant that the fabrics are dyed to a color different than the fabrics' natural color. Dyeing is the process of coloring fibers, yarns or fabrics with dyes or pigments. In many instances, this means that the fabrics are dyed to a non-white color, since bleaching does not appreciably visibly discolor or fade white fabrics. However, where white is not the natural color of the cellulose-based fabric, the colored fabric may be white. Thus, in one embodiment, the fabric is dyed to a color different than the fabric's natural color. In another embodiment, the fabric is dyed to a non-white color. In yet another embodiment, the fabric is dyed white, wherein the natural color of the fabric is not white.

The fabrics of the present invention may be essentially any cellulose-based fabric known in the art. Such cellulosic fabrics include cotton, linen, ramie rayon, hemp, jute, etc. In at least one embodiment, the cellulosic fabrics are constructed by the weaving of yarns using manufacturing processes known in the art. In other embodiments, the cellulosic fabrics are constructed by the knitting of yarns, again using manufacturing processes known in the art. In one embodiment, the fabrics of the present invention are made from cotton fibers or yarns, woven into towels.

The cellulose-based fabrics of the present invention are colored or dyed using pigment colorants. Pigment colorants are different from dye-based colorants in that they originate as solid particles, not liquid solutions. In other words, dye-based colorants are completely soluble in water whereas pigmented colorants are not. Pigment colorants tend to settle into the fibers or yarns of the fabric and, as the dyed fabrics dry, the pigment colorants tend to get stuck in the fibers or yarns and, therefore, are more water resistant than dye-based colorants. Henceforth, the use of the term “dye” or “dyes” will mean pigment colorants.

The pigment colorant of the present invention may be any known pigment colorant known in the art that will provide the color desired to the fabric, including the colors yellow, green and blue. Examples of such pigment colorants, with specific pigments and/or colors specified in parenthesis, include, but are not limited to, arsenic pigments (Paris green); carbon pigments (carbon black, ivory black, vine black lamp black); cadmium pigments (cadmium green, cadmium red, cadmium yellow, cadmium orange); iron oxide pigments (caput mortuum, oxide red, red ochre, sanguine, Venetian red, mars black; Prussian blue pigments; chromium pigments (chrome green, chrome yellow); cobalt pigments (cobalt blue, cerulean blue, cobalt violet, aureolin); lead pigments (lead white, Naples yellow, cremnitz white, red lead); copper pigments (Paris green, verdigris, viridian, Egyptian blue, han purple); titanium pigments (titanium white, titanium beige, titanium yellow, titanium black); ultramarine pigments (ultramarine, ultramarine green shade, French ultramarine); mercury pigments (vermilion); zinc pigments (zinc white); clay earth (iron oxide) pigments (raw sienna, burnt sienna, raw umber, burnt yellow, yellow ochre); organic pigments (pigment red 170, phthalo green, phthalo blue, quinacridone magenta); and lapis lazuli. In one embodiment, the pigments may be selected from organic pigments. In such embodiments, the pigments may be selected from carbon pigments. In other embodiments, the pigments may be selected from inorganic pigments. In one or more of these embodiments, the pigments may be selected from iron oxide pigments. In one or more other embodiments, the pigments may be selected from chromium pigments. In still other embodiments, the pigments may be selected from copper pigments.

The cellulose-based fabrics of the present invention are colored with pigment colorants by utilizing a process known as “pad-dyeing.” Basically, in pad-dyeing, the fabric is passed through a trough of solution or padding paste containing the pigment colorants and then distributed evenly throughout the fabric by squeezing the dye solution into the fabric using a pair of padders or pad mangles. This impregnates the dye deep into the fibers or yarns of the fabric. After padding, the fabric is cured, set and/or further finished by a finishing stenter. The process is generally well known in the art, but has heretofore never been used to impregnate pigment colorants of such ultra fine sizes, on the order of 1 micron or less, into the fabric such that the fabric will withstand chlorine bleaching. In an alternative embodiment, the pad-dyeing process may have the fabric pass between the padders or pad mangles with the bottom pad mangle carrying the padding paste or solution.

The ability of the pad-dyed, pigment-colored cellulose-based fabrics to withstand chlorine bleaching is possible due to improvements in technology with respect to the grinding of pigment colorants. Previous grinders were not capable of grinding the pigment colorants to an ultra fine size of less than 1 micron, if even that small. With new technology, it is now possible to grind pigment colorants of a desired color to an ultra fine size of no larger than 1 micron in diameter using nanotechnology, namely grinders that can ground the pigments into nano-sized particles, previously unavailable and unknown to the pigment industry. Such ultra fine particles have diameters that are sufficiently small to penetrate the fibers of the fabric upon pad dyeing of the fabric.

More particularly, the present invention utilizes ultra fine pigment colorants, the majority of which have been ground to a size of less than about 1 micron in diameter, using specially designed and developed “nano-grinders” that have the ability to grind the pigments to the sizes required for the present invention. In at least one embodiment, the pigment colorants are ground to a size such that a majority of the colorants are less than about 0.8 microns in diameter. In another embodiment, substantially all of the colorants are ground to a size of less than about 1 micron. In still another embodiment, the pigment colorants are ground to a size of between about 100 nanometer and about 1 micron. In another embodiment, the pigment colorants are ground to a size of between about 100 nanometers (0.1 micorns) and about 800 nanometers (0.8 microns). In another embodiment, the pigment colorants are ground to a size of between about 100 nanometers (0.1 microns) and about 400 nanometers (0.4 microns). Such ultra fine pigment colorants, when pad-dyed into a fabric, allow for the maximum penetration of the color into the fibers of the fabric, while maintaining a soft and bulky hand feel.

Once the pigment colorants are ground to a desired particle size, the ground pigment colorants are then blended with one or more binders into a padding paste. Essentially any binders known to be blendable with the pigment colorants of the present invention and soluble in aqueous solution as set forth below may be used in the present invention. However, it will be appreciated that certain binders that provide normal padding pastes often cause the fabric or towel to have a very coarse and harsh hand feel upon passing through the pad-dye process. Therefore, in at least one embodiment of the present invention, a very soft binder is used with the nano- or nearly nano-sized pigment colorants to provide a water soluble paste that not only ensures color fastness of the fabric, but also, with an additional washing process, eliminates the harsh hand feel of the fabric, the washing process dissolving away the harshness, leaving the fabric or towel soft.

One binder suitable for use in the present invention is an acrylic copolymer. This binder is a cationic organic compound that shows great affinity for substrates and produces films with exception adhesion. It is particularly suitable for use when an acrylic binder is to be used in the presence of strongly cationic compounds. This binder can improve the dry and rub fastness and resistance to pilling of the fabric, as well as provide for a soft and bulky hand feel to the fabric.

Once the padding paste is prepared, the paste is then solubilized or, more particularly, emulsified into a water solution, or more particularly, an emulsion. The padding paste for the present invention is a mixture of the grinded, ultra fine pigment colorants and one or more binders. The paste is then combined with an aqueous carrier such that the padding paste solubilizes sufficiently to provide a suitable dye solution used in the pad-dyeing of the fabric. That is, to emulsify the padding paste, the water-paste mixture is stirred at a high speed to provide a homogeneous emulsion in water. The water-paste emulsion is then used as the pad dye solution for pad dyeing the fabrics. The emulsion may include unsolubilized particles of pigment colorants, but these colorants are so small that they penetrate the fibers or yarns of the fabric during the pad dyeing of the fabric. In any event, the grinded pigment colorants and one or more binders should be blended and sufficiently water soluble to provide a padding paste that enables the pad-dye process to be performed easily on normal pad mangles together with finishing stenters for curing.

In one or more embodiments, the pad-dyeing process may continue beyond the curing process of pad dyeing. In at least one embodiment, the process may utilize a second pad finishing process with a fixing agent. The second pad finishing process includes the steps of preparing the fixing agent into an emulsion by stirring the fixing agent in water or an aqueous solution at a high speed to provide a homogeneous emulsion; passing the fabric through a trough containing the fixing agent emulsion and then evenly squeezing the fixing solution or emulsion into the fabric using a pair of padders or pad mangles, thereby providing for the even distribution of the fixing agent into the fabric; and then curing the fabric.

Essentially any fixing agent known in the art and suitable for use as described herein may be used for the present invention. Such a fixing agent improves the crocking fastness of the fabric. For light to medium colors, the dry crocking fastness and wet crocking fastness of the fabrics of the present invention may reach a Grey Scale 4 and 3-4, respectively. For some dark colors, the dry crocking fastness and wet crocking fastness can achieve a Grey Scale 3 and 2-3, respectively. Grey Scale is used to measure color change and color staining and has been developed by the American Association of Textile Chemists and Colorists (AATCC). That is, there are two Gray Scales, one is for evaluating color change, and the other is to evaluate color staining. Each scale has 9 grades as: 5, 4-5,4,3-4, 3, 2-3,2,1-2, 1. In the Grey Scale of color change, Grade 5 indicates no color change, and Grade 1 indicates very serious color change. In the Grey Scale for Color Staining, Grade 5 indicates no staining at all, and Grade 1 indicates very serious color staining. To determine crocking fastness, a crockmeter is used. A standard white fabric is attached to the crockmeter and is then rubbed against the testing fabrics. After a standard numbers of rubbings, the color stained on the white fabric is compared to the Gray Scales for staining to determine the grades of staining. Two crocking fastness tests are usually performed at the same time, one is with the white fabrics in dry condition, and the other is the white fabric wetted with distilled water before the rubbing by the crockmeter.

One example of a suitable fixing agent is a non-ionic, organic composite emulsion soluble in water. This fixing agent is designed as a high performance specialty chemical and as an effective carrier for deep shade pigment continuous dyeing. It is the main functional ingredient used to achieve the deep shade dyeing of pigments on most fabric substrates. It contains multi-functional components for anti-migration, lubricity, absorbency, color enhancement, color fastness and fixation. It is generally applied to fabrics desired to have medium to deep shades of color to that the ratio of its components provide the most effective performance results in the pad dyeing of the fabrics.

In one or more embodiments, the pad-dyeing process may continue beyond the curing process for the second pad finishing with the fixing agent. In at least one embodiment, the process may utilize a finishing setting process. This process may utilize a softening agent to provide higher absorbency and bulkiness to the fabric and provide the user of the fabric a more intimate feel. This finishing setting process includes the steps of washing the fabrics or towels with the aforementioned fixing agent, and/or softening agents, etc. and then tumble drying the fabrics.

Essentially any softening agent known in the art and suitable for use as described herein may be used for the present invention. One example of a softening agent suitable for use in the present invention is actually a combination of ingredients that provide suitable results to the fabrics. These ingredients include a non-ionic softner for resin finish and for conventional finish of fabrics identified as a proprietary fatty acid amine derivative. A second ingredient is a cationic antibacterial textile finishing agent with outstanding rewetting properties for special textile application like terry toweling identified as a proprietary quaternary compound with modified amino. A third ingredient is a concentrated textile finishing agent comprising an amino-modified polydimethyl siloxane micro-emulsion. The micro-emulsion is used for treating various kinds of fabrics to impart pliability, smoothness, crease resistance, soft and velvet-like hand feel to the fabrics. Hence, it also enhances smooth and soft feel, has good drape characteristics, has low yellowing, provides increased fabric elasticity and crease recovery, and improves tensile strength and tear strength. Yet a fourth ingredient is an alkylphenol ethoxylate. It is a wetting agent and detergent for the textile industry. It is water free, nonionic, and very good at emulsifying and scouring oils and fatty substances. It activates the enzymes for degradising the starch in desizing liquors. It also prevents the build up of deposits on the pad rollers in resin finishing liquors.

It will be appreciated that the pad-dyed, pigment-colored, cellulose-based fabrics of the present invention do not discolor or fade during chlorine bleaching. In order to demonstrate this characteristic of withstanding chlorine bleaching, sample fabrics, woven into towels and pad-dyed according to the concepts of the present invention as set forth hereinabove, were subjected to the Clorox-5X test. The Clorox-5X test uses the common bleaching agent and the bleaching agent found in Clorox® bleach, sodium hypochlorite, in a series of bleaching cycles to determine whether the fabric will withstand chlorine bleaching. The Clorox-5X test refers to bleaching of the fabric through five (5) cycles. The Clorox-1X test refers to bleaching of the fabric through one (1) cycle. A cycle includes bleach washing a test sample with the bleaching chemical known by the tradename Clorox, at a concentration in water of 4 g/L, at 40° C., for 20 minutes. Subjecting a fabric to 5 bleach washing cycles is a very strong bleaching action that should not be used for home washing of fabrics. However, if the fabric can withstand bleaching under the Clorox-5X test, it indicates that the fabrics are bleach-resistant, or capable of withstanding chlorine bleach. Upon completion of the Clorox-5X test, the fabrics either pass or fail the test. Whether a fabric passes or fails the Clorox-5X test can be determined by using the Gray Scale of color change measure described above. That is, to pass the Clorox-5X test, the fabric should be graded or measure at least a 4 on the Gray Scale of color change test. That is, fabrics receiving a grade of 4 or better (i.e., 4-5 or 5) on the Gray Scale measurement have been determined to be commercially acceptable to the hospitality industry.

Thus, many fabrics dyed according to the present invention have been found to pass the Clorox-5X test by receiving a grade of 4 or better. That is, towels dyed to certain colors as set forth in the present invention have withstood bleaching with normal home bleaching chemicals as well as up to the industrial standards of the industrial laundries for the hospitality industry.

It will also be appreciated that the fabrics and towels of the present invention are pad dyed with ultra fine-sized pigment colorants, so as to allow maximum penetration of the color into the towels, while the hand feel of the towels remain very soft and bulky, comparable to that of vat-dyed fabrics. Hand feel may be measured objectively for many fabrics by the Kawabata Evaluation System (KES-FB system) developed in Japan. However, this test oftentimes cannot be performed on certain thicker fabrics, such as towels. Therefore, an alternative system, known as the Fabric Assurance by Simple Testing system or FAST system, was developed by the Commonwealth Scientific and Industrial Research Organisation (CSIRO) in Australia. Like the KES-FB system, the FAST system can objectively measure the hand feel of fabrics, but does so without certain factors used by the KES-FB system, so as to allow the determination of hand feel for many other fabrics such as towels. The FAST system is specifically designed for use by tailors to highlight problems that may be encountered in making a fabric into garments. The system is claimed to be much simpler and more robust than the KES-FB system.

Like the KES-FB system, the FAST system requires a set of instruments with which to measure various fabric properties and then correlates those measurements with the subjective assessment of hand feel. The aim is to provide an objective test that enables reproducibility of the measurements of a fabric. In the FAST system, fabric specimens undergo testing for bending rigidity, compression, shear rigidity, and weight. Bending rigidity relates to the force needed to bend the fabrics. The higher the bending rigidity is, the stiffer the fabric is. Compression, or compressibility, relates to the ability to press down or compress the fabric. A fabric that can be pressed down deeply, or is highly compressible is said to be more bulky and have a softer hand feel. Heavier weight, non-colored, and thicker fabrics tend to have higher compressibility. This is one reason why white fabrics are said to have the highest compressibility. Shear rigidity relates to the force needed for flexibility. Again, like bending rigidity, the higher the shear rigidity, the more rigid the fabric. Various instruments known in the art measure these properties.

In order to demonstrate the soft hand feel and bulkiness of the pad-dyed fabrics of the present invention, sample towels were pad-dyed, vat-dyed or not dyed at all, i.e., remained white. Each sample towel was then measured using the FAST system. The results of these tests are shown in TABLE I below.

TABLE I
FAST System Tests on Pad-Dyed, Vat-Dyed and Non-Dyed
(White) Towels

| | Types | | | | |
|---|---|---|---|---|---|
| | Pad | Pad | Vat | Vat | Non- |
| | dyed | dyed | dyed | dyed | dyed |
| | towel-1 | towel-2 | towel-1 | towel-2 | (white) |
| Bending Rigidity | | | | | |
| (μN · m) | | | | | |
| Warp | 22.1 | 19.5 | 17.0 | 16.1 | 24.0 |
| Weft | 12.1 | 12.5 | 13.7 | 15.4 | 32.5 |
| Mean | 17.10 | 16.00 | 15.35 | 15.75 | 28.25 |
| Compression | | | | | |
| T2 (mm) | 3.554 | 3.644 | 3.749 | 3.393 | 4.569 |
| T100 (mm) | 1.917 | 2.006 | 2.173 | 1.967 | 2.347 |
| ST = (T2 − T100) | 1.637 | 1.638 | 1.576 | 1.426 | 2.222 |
| T2 − T100/T2 (%) | 46.06 | 44.95 | 42.04 | 42.02 | 48.63 |
| Shear Rigidity (N/m) G | 25.80 | 28.17 | 29.06 | 24.76 | 40.55 |
| Weight (g/sq.cm) W | 448 | 465 | 436 | 442 | 554 |

In viewing the results of the FAST system tests, it is clear that the pad-dyed towels and vat-dyed towels have very similar results. As vat-dyed towels, meaning those towels that are dyed in a dye-bath or vat, are known to be very soft and bulky, so too then are the pad-dyed towels of the present invention very soft and bulky.

In reviewing the results, it can be seen that the white, non-dyed towel has the highest bending rigidity and that both the pad-dyed towels and the vat-dyed towels have much lower bending rigidity. The pad-dyed towels have a bending rigidity that is similar to the bending rigidity of the vat-dyed towels and are considered to have similar softness. For compression, the heavier weighted white towel has the highest compression. However, it may be because of the weight that this is true. In comparing the pad-dyed and vat-dyed towels, which are of similar weights, the pad-dyed towels have a slightly greater compressibility. Finally, the highest shear rigidity is shown by the non-dyed towels, while the pad-dyed and vat-dyed towels have similar shear rigidity, meaning that these two types of dyed towels have similar levels of rather low rigidity, i.e., are more flexible than the non-dyed towels.

Thus, it should now be evident that the grinded ultra fine (i.e., nano-sized or nearly nano-sized) pigment colorants can produce a wide array of colors for the fabrics, including bright yellow, green and blue, and that all colors can stand bleaching with normal home bleaching chemicals as well as up to the industrial standards of the industrial laundries for the hospitality industry. It should be further evident that the pad dyeing process provides the fabrics and, particularly, cotton towels, with highly satisfactory performance for colors that are bleachable, high absorbency, soft and bulky hand feel, high color fastness in washing and high color fastness in wet and dry crocking.

In another embodiment and as an alternative to pad-dyeing, the fabrics of the present invention may be pigment dyed using other known methods of dyeing, other than vat dyeing which process is limited as described above. For example, it has been found that certain foam dyeing processes may provide an alternative method to applying pigment dyes to the fabrics. One system, known as the chemical foam system (CFS), is a highly controlled, patented system that has been used to accurately apply foamed, water soluble or water dispersible chemicals at very low moisture levels onto substrates such as textiles, carpets, non-woven, and paper and the like. In the context of the present invention, such chemicals may include pigment dyes for use on knitted or woven fabrics. Applying foam to woven and knitted fabrics use a pressure plenum which provides finite control over the chemical application to the fabrics with respect to uniform, quality and controlled penetration of the fabric. Foam application may be advantageous to the extent that the surface area of the chemical or dye, when foamed, more closely matches the surface area of the fibers or yarns while greatly reducing water usage.

Most all chemicals, including dyes and pigments, are foamable in some form or other. Other chemicals capable of being foamed include, but are not limited to, resins, binders, softners, lubricants, repellents of soil, oil, water, and stains, to name a few.

The foam dyeing process can be used to apply pigments of a desired color to fabrics and, particularly, cellulose-based fabrics. The pigment is first grinded down to the sizes described above, using the “nano-grinders” noted above, and prepared into a highly homogeneous solution in a manner similar to, if not the same as, the pad-dyeing process. The prepared dyestuff solution is measured and fed into the foam generator at a pre-determined quantity through the control of a liquid flow meter. Compressed air, also measured by the air flow meter, is fed into the foam generator at a pre-determined amount. The pigment solution and air are fed into the foam generator simultaneously and accurately to make the foam mix. The foam is generated from the generator to the applicator slot, is maintained at a positive pressure over the atmospheric pressure until it reaches the slot and is added onto the substrate. The foam remains its uniform condition and collapses at the surface of the substrate when exposed to the atmosphere. There is no premature break-up of the foam cells before it leaves the applicator chamber. The pigment foam is then applied onto the fabric through a parabolic applicator, which ensures that all foam bubbles travel the same distance from the entry point to the fabric. In this way, there are practically no side-by-side or end-to-end shading differences. Therefore, the use of foam-dyed, cellulose-based fabrics made from the application of foamed chemicals containing pigments of a desired color would appear to be suitable for the present invention, provided the fabrics do not discolor upon chlorine bleaching of the fabric. In addition, as noted above, the process can also apply any of a number of different functional chemicals onto the fabric as well, such as repellents of soil, water, stains, and dirt, softeners, anti-bacterial chemicals and the like. A more detailed discussion of the chemical foam system may be found in the Chemical Foam System (2007) brochure supplied by Gaston Systems, Inc. of Stanley, N.C., the entire brochure of which is hereby incorporated by reference.

Thus, it will be appreciated that several alternative embodiments and structural equivalents of the fabrics are contemplated. By making a fabric bleachable, it is further possible to add many other functional properties including, but not limited to high water absorbency, soil release, odor-absorbent, anti-bacterial, anti-fungal, anti-viral, and mosquito repellant effects. With nano-encapsulation, fragrances, zinc oxides, titanium oxides, to protect against ultraviolent rays, skin protecting agents, skin nurturing agents, vitamins, homeopathic compounds and mixtures thereof, can be incorporated into the fabrics and still withstand chlorine bleaching. By nano-encapsulation, it is meant that the storing capsules are made to nano-sizes. They are used to store the aforementioned functional chemicals, which would be released through rubbing, pressing, etc. It is perceived that such functional properties are highly desirable in the hospitality industry. In the case of pet clothing, valuable and applicable features such as dirt and stain release, anti-mite, anti-flea properties can also be added to the fabric.

In light of the foregoing, it should thus be evident that the present invention substantially improves the art of bleachable fabrics, and provides particular advantages for pad-dyed fabrics and foam-dyed fabrics. While a full and complete description of the invention has been set forth in accordance with the dictates of the patent statutes, it should be understood that modifications can be resorted to without departing from the spirit hereof or the scope of the appended claims.

What is claimed is:

1. A pad-dyed, pigment-colored, cellulose-based fabric that does not discolor upon chlorine bleaching of the fabric.

2. The pad-dyed, pigment-colored, cellulose-based fabric of claim 1, wherein the fabric can withstand bleaching under the Clorox 5X test.

3. The pad-dyed, pigment-colored, cellulose-based fabric of claim 1, wherein the fabric has a soft hand feel.

4. The pad-dyed, pigment-colored, cellulose-based fabric of claim 1, wherein the fabric is highly absorbent.

5. The pad-dyed, pigment-colored, cellulose-based fabric of claim 1, wherein at least one additive selected from the group consisting of fragrances, anti-bacterial agents, anti-fungal agents, anti-viral agents, insect repellents, zinc oxide, titanium oxide to protect against UV rays, skin protecting agents, skin nurturing agents, vitamins, homeopathic compounds, and mixtures thereof, is incorporated into the fabric.

6. A method for dyeing a cellulose fiber-based fabric comprising:
grinding pigment colorants of a desired color to a size no larger than about 1 micron in diameter;
blending the grinded pigment colorants with one or more binders and, optionally, one or more additives, to form a padding paste;
preparing the padding paste for use in pad dyeing; and
pad dyeing the fabric.

7. The method of claim 6, wherein the step of grinding includes grinding the pigment colorants to a diameter size of between about 100 nanometer and about 1 micron.

8. The method of claim 6, wherein the step of blending includes blending the grinded pigment colorants with a cationic organic binder.

9. The method of claim 8, wherein the cationic organic binder is an acrylic copolymer.

10. The method of claim 6, wherein the one or more additives are selected from the group consisting of fixing agents and softening agents.

11. The method of claim 10, wherein the fixing agent includes a non-ionic, organic composite emulsion soluble in water.

12. The method of claim 10, wherein the softening agents include a one or more of a non-ionic softener containing a fatty acid amine derivative, a cationic textile finishing agent containing a quaternary compound with modified amino silicone; an amino-modified polydimethylsiloxane micro-emulsion, and a non-ionic alkylphenol ethoxlate.

13. The method of claim 6, wherein the step of preparing includes solubilizing the padding paste in water.

14. The method of claim 13, wherein the step of solubilizing includes stirring the padding paste at a high speed to provide a homogeneous emulsion in water wherein any unsolubilized particles of pigment colorants are so small that they penetrate the fibers of the fabric during pad dyeing.

15. The method of claim 14, wherein the step of pad dyeing includes:
passing the fabric through a trough of the solubilized padding paste;
squeezing the fabric evenly through a pair of pad mangles to impregnate the pigment colorants into the fibers of the fabric; and
curing the dyed fabric.

16. A colored fabric of cellulose fibers, the fabric comprising:
pigment colorants of a desired color having a diameter sufficiently small to penetrate the fibers of the fabric upon pad dyeing of the fabric.

17. The colored fabric of cellulose fibers of claim 16, wherein the pigment colorants remain attached to the fabric during chlorine bleaching.

18. The colored fabric of cellulose fibers of claim 16, wherein the fabric is a cotton towel.

19. A foam-dyed, pigment-colored, cellulose-based fabric that does not discolor upon chlorine bleaching of the fabric.

20. A method for dyeing a cellulose fiber-based fabric comprising:
grinding pigment colorants of a desired color to a size no larger than about 1 micron in diameter;
blending the grinded pigment colorants with one or more binders and, optionally, one or more additives, to form a padding paste;
preparing the padding paste for use in foam dyeing; and
foam dyeing the fabric.
